(19) United States
(12) Patent Application Publication
(10) Pub. No.: US 2011/0112264 A1
(43) Pub. Date: May 12, 2011

(54) PROCESS FOR PRODUCING POLYMERIZATION CATALYST OF ALKYLENE OXIDE AND POLY(ALKYLENE OXIDE)

(75) Inventors: Shigeyoshi KANOH, Kanazawa-Shi (JP); Masaaki NABIKA, Ichihara-shi (JP)

(73) Assignees: SUMITOMO CHEMICAL COMPANY, LIMITED, Tokyo (JP); National University Corporation Kanazawa University, Kanazawa-shi (JP)

(21) Appl. No.: 12/911,802

(22) Filed: Oct. 26, 2010

(30) Foreign Application Priority Data
Nov. 10, 2009 (JP) 2009-256848

(51) Int. Cl. C08F 4/52; B01J 31/14; B01J 31/02

(52) U.S. Cl. 526/189; 502/152; 502/156

(57) ABSTRACT

A production process of a polymerization catalyst of an alkylene oxide, comprising a step of contacting an alumoxane compound with a compound having a hydroxyl group; a production process of a pre-polymerized polymerization catalyst thereof, comprising a step of pre-polymerizing an alkylene oxide in the presence of the above polymerization catalyst; and a production process of a poly(alkylene oxide), comprising a step of polymerizing an alkylene oxide in the presence of the above polymerization catalyst or pre-polymerized polymerization catalyst.

### FIELD OF THE INVENTION

The present invention relates to a process for producing a polymerization catalyst of an alkylene oxide, and a process for producing a poly(alkylene oxide) having high molecular weight.

### BACKGROUND OF THE INVENTION

There is known a polymerization method of an alkylene oxide using an organoaluminum compound. Examples of such a polymerization method are (1) a polymerization method using bis(diethylaluminum)oxide, which is disclosed in Journal of the American Chemical Society/89:1/Jan. 4, 1967 173-174, (2) a polymerization method using triisobutylaluminum-modified methylalumoxanes, or using a solid methylalumoxane, which is disclosed in Macromolecules 2003, 36, 5470-5481, and (3) a polymerization method comprising a step of contacting an alkylene oxide, a lanthanoid complex, and an organoaluminum compound with one another, which is disclosed in JP11-12351A, JP11-12352A or JP11-12353A.

### SUMMARY OF THE INVENTION

However, the above polymerization methods produce only a low molecular weight poly(alkylene oxide). And so there has been desired a polymerization method which can produce a high molecular weight poly(alkylene oxide).

In view of the above circumstance, an object of the present invention is to provide a process for producing a polymerization catalyst of an alkylene oxide, and a process for producing a high molecular weight poly(alkylene oxide) by use of a polymerization catalyst produced by such a process.

The present invention is a process for producing a polymerization catalyst of an alkylene oxide, comprising a step of contacting an alumoxane compound with a compound having a hydroxyl group. This process is referred to hereinafter as “catalyst production process-1”.

Also, the present invention is a process for producing a poly(alkylene oxide), comprising a step of polymerizing an alkylene oxide in the presence of a polymerization catalyst of an alkylene oxide produced by above catalyst production process-1. This process is referred to hereinafter as “polymer production process-1”.

Further, the present invention is a process for producing a pre-polymerized polymerization catalyst of an alkylene oxide, comprising steps of:

(1) contacting an alumoxane compound with a compound having a hydroxyl group, thereby forming a polymerization catalyst of an alkylene oxide; and

(2) pre-polymerizing an alkylene oxide in the presence of the polymerization catalyst of an alkylene oxide, an amount of the alkylene oxide pre-polymerized being 0.1 to 10 moles per one mole of an aluminum atom contained in the polymerization catalyst of an alkylene oxide. This process is referred to hereinafter as “catalyst production process-2”.

Still further, the present invention is a process for producing a poly(alkylene oxide), comprising a step of polymerizing an alkylene oxide in the presence of a pre-polymerized polymerization catalyst of an alkylene oxide produced by above catalyst production process-2. This process is referred to hereinafter as “polymer production process-2”.

The above “compound having a hydroxyl group” is hereinafter referred to as “hydroxyl group-having compound”.

### DETAILED DESCRIPTION OF THE INVENTION

An alumoxane compound in the present invention is a compound having a direct linkage of an aluminum atom to a carbon atom, and to an oxygen atom. Examples of the alumoxane compound are those represented by following formula (1) or (2):

{—Al(E¹)-O—}_{b} (1)

E²{—Al(E²)-O—}_{c}AlE²₂ (2)

wherein E¹ is a hydrocarbyl group, and plural E¹s are the same as, or different from each other; b is an integer of 2 or more; E² is a hydrocarbyl group, and plural E²s are the same as, or different from each other; and c is an integer of 1 or more.

E¹ is preferably a hydrocarbyl group having 1 to 20 carbon atoms, and more preferably an alkyl group having 1 to 20 carbon atoms. Examples of the alkyl group are a methyl group, an ethyl group, a n-propyl group, an isopropyl group, a n-butyl group, an isobutyl group, a n-pentyl group, and a neopentyl group. Among them, preferred is a methyl group or an isobutyl group. Above b is preferably an integer of 2 to 40.

E² is preferably a hydrocarbyl group having 1 to 20 carbon atoms, and more preferably an alkyl group having 1 to 20 carbon atoms. Examples of the alkyl group are a methyl group, an ethyl group, a n-propyl group, an isopropyl group, a n-butyl group, an isobutyl group, a n-pentyl group, and a neopentyl group. Among them, preferred is a methyl group or an isobutyl group. Above c is preferably an integer of 1 to 40.

Examples of a process for producing a compound represented by formula (1) or (2) are (i) a process comprising a step of contacting water with a solution of a trialkylaluminum (for example, trimethylaluminum) in an organic solvent (for example, benzene and an aliphatic hydrocarbon), and (ii) a process comprising a step of contacting a crystal water-containing metal salt (for example, copper sulfate hydrate) with a trialkylaluminum (for example, trimethylaluminum), both processes being known in the art.

The above alumoxane compound may be a commercially-available product. Examples of the commercially-available product are PMAO-S and TMAO-211 produced from trimethylaluminum; MAO-3A, MMAO-4 and TMAO-341 produced from a mixture of trimethylaluminum with triisobutylaluminum; and PBAO produced from triisobutylaluminum, all being produced by TOSOH FINECHEM CORPORATION. Further examples of the commercially-available product are a 30% solution of MAO in toluene, and a 10% solution of MAO in toluene, both being produced from trimethylaluminum by Albemarle Corp. The alumoxane compound is preferably methylalumoxane.

The hydroxyl group-having compound in the present invention is a compound having one or more hydroxyl groups in its molecule. Examples of the hydroxyl group-having compound are water, alcohols, phenols, carboxylic acids, and sugars.

Examples of the alcohols are a monohydric alcohol such as methanol, ethanol, n-propanol, isopropanol, n-butanol, isobutanol, sec-butanol, tert-butanol, n-pentanol, n-hexanol, n-heptanol, and n-octanol; and a dihydric alcohol such as ethylene glycol and propylene glycol. These alcohols may be substituted with a halogen atom such as a fluorine atom, a chlorine atom, a bromine atom, and an iodine atom. Examples of the halogen atom-substituted alcohols are fluoromethanol, chloromethanol, bromomethanol, iodomethanol, difluoromethanol, dichloromethanol, dibromomethanol, diiodomethanol, trifluoromethanol, trichloromethanol, tribromomethanol, triiodomethanol, 2,2,2-trifluoroethanol, 2,2,2-trichloroethanol, 2,2,2-tribromoethanol, 2,2,2-triiodoethanol, 2,2,3,3,3-pentafluoropropanol, 2,2,3,3,3-pentachloropropanol, 2,2,3,3,3-pentabromopropanol, 2,2,3,3,3-pentaiodopropanol, 2,2,2-trifluoro-1-trifluoromethylethanol, 2,2,2-trichloro-1-trichloromethylethanol, 2,2,2-tribromo-1-tribromomethylethanol, 2,2,2-triiodo-1-triiodomethylethanol, 1,1-bis(trifluoromethyl)-2,2,2-trifluoroethanol, 1,1-bis(trichloromethyl)-2,2,2-trichloroethanol, 1,1-bis(tribromomethyl)-2,2,2-tribromoethanol, and 1,1-bis(triiodomethyl)-2,2,2-triiodoethanol.

Examples of the above phenols are phenol and substituent-having phenols. The substituent is preferably a halogen atom (for example, a fluorine atom, a chlorine atom, a bromine atom, and an iodine atom), an alky group, an aralkyl group, an aryl group, a silyl group, an alkoxy group, an aralkyloxy group, an aryloxy group, or a silyloxy group. All of these groups may be substituted with a halogen atom. Specific examples of the phenols are 2-methylphenol, 2-ethylphenol, 2-n-butylphenol, 2-isobutylphenol, 2-tert-butylphenol, 2-n-propylphenol, 2-isopropylphenol, 2-phenylphenol, 2,6-dimethylphenol, 2,6-diethylphenol, 2,6-di-n-butylphenol, 2,6-diisobutylphenol, 2,6-di-tert-butylphenol, 2,6-di-n-propylphenol, 2,6-diisopropylphenol, 2,6-diphenylphenol, 3,4,5-trifluorophenol, 3,4,5-tris(trifluoromethyl)phenol, 3,4,5-tris(pentafluorophenyl)phenol, 3,5-difluoro-4-pentafluorophenylphenol, 4,5,6,7,8-pentafluoro-2-naphthol, 3,4,5-trichlorophenol, 3,4,5-tris(trichloromethyl)phenol, 3,4,5-tris(pentachlorophenyl)phenol, 3,5-dichloro-4-pentachlorophenylphenol, 4,5,6,7,8-pentachloro-2-naphthol, 3,4,5-tribromophenol, 3,4,5-tris(tribromomethyl)phenol, 3,4,5-tris(pentabromophenyl)phenol, 3,5-dibromo-4-pentabromophenylphenol, 4,5,6,7,8-pentabromo-2-naphthol, 3,4,5-triiodophenol, 3,4,5-tris(triiodomethyl)phenol, 3,4,5-tris(pentaiodophenyl)phenol, 3,5-diiodo-4-pentaiodophenylphenol, 4,5,6,7,8-pentaiodo-2-naphthol, 3,5-difluoro-4-nitrophenol, 3,5-dichloro-4-nitrophenol, 3,5-dibromo-4-nitrophenol, 3,5-diiodo-4-nitrophenol, 3,5-difluoro-4-cyanophenol, 3,5-dichloro-4-cyanophenol, 3,5-dibromo-4-cyanophenol, 3,5-diiodo-4-cyanophenol, 2,3,5,6-tetrachlorophenol, 2,3,5,6-tetrabromophenol, 2,3,5,6-tetraiodophenol, pentafluorophenol, pentachlorophenol, pentabromophenol, and pentaiodophenol.

Examples of the above carboxylic acids are a saturated aliphatic carboxylic acid such as formic acid, acetic acid, propionic acid, butyric acid, valeric acid, caproic acid, lauric acid, and stearic acid; a halogenated and saturated aliphatic carboxylic acid such as trifluoroacetic acid, trichloroacetic acid, perfluoropropionic acid, perfluorobutyric acid, perfluorovaleric acid, perfluorocaproic acid, perfluorolauric acid, and perfluorostearic acid; an unsaturated aliphatic carboxylic acid such as oleic acid, linoleic acid, linolenic acid, docosahexaenoic acid, and eicosapentaenoic acid; an aliphatic dicarboxylic acid such as oxalic acid, malonic acid, succinic acid, fumaric acid, maleic acid, glutaric acid, and adipic acid; an aromatic carboxylic acid such as benzoic acid, phthalic acid, isophthalic acid, terephthalic acid, salicylic acid, and cinnamic acid; and a halogenated aromatic carboxylic acid such as perfluorobenzoic acid, perfluorophthalic acid, perfluoroisophthalic acid, perfluoroterephthalic acid, and perfluorosalicylic acid.

Examples of the above sugars are following (1) to (6):

(1) sugar represented by the formula, CₙH₂ₘOₘ;
(2) polyhydric alcohols;
(3) aldehyde derivatives, ketone derivatives, or carboxylic acid derivatives of above sugar (1);
(4) aldehyde derivatives, ketone derivatives, or carboxylic acid derivatives of above polyhydric alcohols (2);
(5) acetal-protected products of above (1), (2), (3) or (4); and
(6) ketal-protected products of above (1), (2), (3) or (4).

Specific examples of the above sugars are aldoses such as glyceraldehyde, erythrose, threose, ribose, arabinose, xylose, lyxose, allose, altrose, glucose, mannose, gulose, idose, and galactose; ketoses such as dihydroxyacetone, erythrulose, ribulose, xylulose, psicose, fructose, sorbose, tagatose, sedoheptulose, and coriose; disaccharides such as trehalose, isotrehalose, kojibiose, sophorose, nigerose, laminaribiose, maltose, cellobiose, isomaltose, gentiobiose, lactose, and sucrose; oligosaccharides such as fructo-oligosaccharide, galacto-oligosaccharide and lactosucrose; polysaccharides such as starch, amylose, amylopectin, glycogen, cellulose, pectin, and glucomannan; lactones such as ascorbic acid, glucuronolactone, and gluconolactone; sugar alcohols such as glycerin, xylitol, and sorbitol; amino acids such as glucosamine and galactosamine; uronic acids such as glucuronic acid and galacturonic acid; and deoxysugars such as deoxyribose, fucose and rhamnose.

The hydroxyl group-having compound is preferably water, alcohols, phenols or carboxylic acids, more preferably water, phenols or carboxylic acids, and further preferably water, pentafluorophenol or pentafluorobenzoic acid.

The hydroxyl group-having compound is used in an amount of preferably 0.05 to 2 mol-OH/mol-Al, and more preferably 0.1 to 1 mol-OH/mol-Al, in terms of an amount by mole of a hydroxyl group (mol-OH) contained in the hydroxyl group-having compound used, per one mole of an aluminum atom (mol-Al) contained in the alumoxane compound used.

The alumoxane compound and the hydroxyl group-having compound are contacted with each other at usually −80 to 100° C., preferably −30 to 50° C., and more preferably 0 to 30° C.

The above contact may be carried out in a solvent. Examples of the solvent are an aromatic hydrocarbon solvent such as benzene, toluene and xylene; an aliphatic hydrocarbon solvent such as n-hexane and n-heptane; and an alicyclic hydrocarbon solvent such as cyclohexane; a halogenated hydrocarbon solvent such as dichloromethane, dichloroethane, chlorobenzene, and dichlorobenzene; and a combination of two or more thereof. Among them, preferred is an aromatic hydrocarbon solvent, an aliphatic hydrocarbon solvent or an alicyclic hydrocarbon solvent, and more preferred is toluene, xylene, n-hexane, cyclohexane or n-heptane. The solvent is used in an amount of usually 10 to 2,000 parts by weight, and preferably 100 to 1,000 parts by weight, per one part by weight of the alumoxane compound.

Examples of the alkylene oxide in the present invention are ethylene oxide, propylene oxide, 1-butene oxide, 2-butene oxide, isobutylene oxide, 1-pentene oxide, 2-pentene oxide, 1-hexene oxide, 1-octene oxide, 1-decene oxide, cyclopentene oxide, cyclohexene oxide, styrene oxide, vinylcyclohexane oxide, 3-phenylpropylene oxide, 3,3,3-trifluoropropylene oxide, 3-naphthylpropylene oxide, 3-phenoxypropylene oxide, 3-naphthoxypropylene oxide, butadiene monoxide, 3-vinyloxypropylene oxide, 3-trimethylsilyloxypropylene oxide, methylglycidyl carbonate, ethylgiycidyl carbonate, cholesterylglycidyl carbonate, and a combination of two or more thereof. Among them, preferred is ethylene oxide, propylene oxide, 1-butene oxide, 2-butene oxide, isobutylene oxide, 1-hexene oxide, 1-octene oxide, 1-decene oxide or cyclohexene oxide, and more preferred is propylene oxide.

Polymer production processes-1 and -2 of the present invention are conducted, for example, by a solution or slurry polymerization method using a solvent, or by a gas phase polymerization method carried out at a boiling temperature of an alkylene oxide as a monomer, or higher. Those polymerization methods are a continuous or batch-wise method. Examples of the above solvent are an aliphatic hydrocarbon such as butane, pentane, hexane, heptane and octane; an aromatic hydrocarbon such as benzene and toluene; and a halogenated hydrocarbon such as methylene dichloride.

An alkylene oxide is polymerized at preferably −70 to 150° C., and more preferably 0 to 50° C. Its polymerization time is, in general, suitably determined in the light of (i) a change rate of an alkylene oxide to a poly(alkylene oxide), (ii) polymerization temperature, and (iii) a monomer concentration in a polymerization liquid, and is usually 1 minute to 100 hours, preferably 1 to 80 hours, and more preferably 24 to 80 hours.

In catalyst production process-2, pre-polymerization of an alkylene oxide is carried out in the presence of a polymerization catalyst produced by catalyst production process-1, thereby producing a pre-polymerized polymerization catalyst, which is used for polymerization of an alkylene oxide in polymer production process-2. The former term “pre-polymerization of an alkylene oxide” is used in contrast to the latter term “polymerization of an alkylene oxide”. Therefore, the latter polymerization may be referred to as “main polymerization” in contrast to “pre-polymerization”. In the pre-polymerization, an alkylene oxide is polymerized in an amount of 0.1 to 10 moles, per one mole of an aluminum atom contained in the polymerization catalyst produced by catalyst production process-1, which amount is much smaller than that in the main polymerization. When using a pre-polymerized polymerization catalyst, a yield of a poly(alkylene oxide) is improved; that is, polymer production process-2 using a pre-polymerized polymerization catalyst is higher than polymer production process-1 in its poly(alkylene oxide) yield.

A poly(alkylene oxide) produced by polymer production process-1 or -2 is high in its molecular weight. Its number-average molecular weight (Mₙ) is preferably 100,000 or higher, more preferably 500,000 or higher, and further preferably 5,000,000 or higher.

Polymer production process-1 or -2 can produce a stereoregular isotactic poly(alkylene oxide) by polymerizing an alkylene oxide such as propylene oxide, 1-butene oxide, 1-hexene oxide, styrene oxide and cyclohexene oxide. The stereoregularity can be measured by a ¹³C-NMR method. For example, stereoregularity of poly(propylene oxide) is measured generally based on a value of integral of its methine carbon, according to a method disclosed in detail in Macromolecules, Vol. 19, No. 5, pages 1337-1343 (September 1986) edited by American Chemical Society. The higher the stereoregularity of a poly(alkylene oxide) is, the higher crystallinity of the poly(alkylene oxide) is. The stereoregularity is shown by an isotactic triad fraction (mm). In the present invention, the isotactic triad fraction is preferably 81% or more, and when using a poly(propylene oxide), for example, as a film, it is more preferably 90% or more, and further preferably 99% or more.

A poly(alkylene oxide) in the present invention has such a high molecular weight that the poly(alkylene oxide) is high in its thermal decomposition temperature. Therefore, the poly(alkylene oxide) in the present invention can be suitably used as a heat-resistant film.

### EXAMPLE

The present invention is explained in more detail with reference to the following Examples, which do not limit the present invention.

### Example 1

A toluene solution of PMAO-S (alumoxane compound) was weighed out in an amount corresponding to 10.0 mmol-Al of PMAO-S, by use of a 50 mL flask purged with nitrogen gas, the toluene solution of PMAO-S being manufactured by TOSOH FINECHEM CORPORATION. The toluene solution in the flask was diluted with 20 mL of dehydrated toluene. A 36 mg (2.0 mmol) of water (hydroxyl group-having compound), which had been degassed previously at room temperature, was added to the PMAO-S solution under stirring, and then the mixture was stirred for one hour. Volatile components in the flask were removed under reduced pressure, and the resultant material was dried in a vacuum for one hour, thereby yielding a white powder (polymerization catalyst of alkylene oxide).

To a 100 mL flask purged with nitrogen gas was charged 49.8 mg of the above-obtained white powder, and then 51.2 mL of dehydrated toluene was added thereto, thereby dissolving the white powder in toluene. A 6.0 mL of propylene oxide (alkylene oxide) was added to this toluene solution. The reaction mixture was stirred at 35° C. for 72 hours. The polymerization reaction was quenched by adding 3.0 mL of concentrated sulfuric acid. The mixture was neutralized with aqueous sodium hydroxide, and was separated into an oil layer and an aqueous layer. Volatile components in the oil layer were removed with a rotary evaporator, thereby obtaining 0.45 g of poly(propylene oxide).

A GPC (gel permeation chromatography) measurement of the above-obtained poly(propylene oxide) indicated two peaks in a peak strength ratio of 40.5:59.5. The former peak was found to correspond to poly(propylene oxide) (hereinafter, referred to as “polymer (i)) having number-average molecular weight (Mₙ) of 15,320,000, and weight-average molecular weight (M_{w}) of 29,100,000 (therefore, its molecular weight distribution (M_{w}/Mₙ)=29,100,000/15,320,000=1.9), and the latter peak was found to correspond to poly(propylene oxide) (hereinafter, referred to as “polymer (ii)) having number-average molecular weight (Mₙ) of 1,200, and weight-average molecular weight (M_{w}) of 2,300 (therefore, its molecular weight distribution (M_{w}/Mₙ)=2,300/1,200=1.9). The above-obtained poly(propylene oxide) was separated with use of acetone into above polymer (i) and polymer (ii). Polymer (i) was found to be isotactic poly(propylene oxide) having 99% or more of isotactic triad, and polymer (ii) was found to be atactic poly(propylene oxide), measured by a ¹³C-NMR method. Results are shown in Table 1.

The above number-average molecular weight (Mₙ) and weight-average molecular weight (M_{w}) (therefore, also M_{w}/Mₙ) were measured by gel permeation chromatography (GPC) under the following conditions, using a calibration curve prepared by use of standard polystyrenes:

measurement apparatus: LC-2000PLUS series manufactured by JASCO Corporation;

column: TSK-GELG-6000, G-5000, G-4000 and G-3000HXL, manufactured by TOSOH Corporation, these four columns being connected in series;

measurement temperature: 40° C.;

solvent: tetrahydrofuran; and

sample concentration: 70 mg/mL.

The above ¹³C-NMR method was conducted under the following conditions:

measurement apparatus: 400 MHz-NMR manufactured by JEOL Ltd.;

measurement temperature: 23° C.;

solvent: chloroform-d; and

sample amount: 10 mg.

### Example 2

Example 1 was repeated except that water was changed to 2.0 mmol of pentafluorophenol, thereby obtaining 0.43 g of poly(propylene oxide).

A GPC (gel permeation chromatography) measurement of the above-obtained poly(propylene oxide) indicated two peaks in a peak strength ratio of 43.1:56.9. The former peak was found to correspond to poly(propylene oxide) having Mₙ of 5,890,000, and M_{w} of 50,100,000 (therefore, its M_{w}/Mₙ=50,100,000/5,890,000=8.5), and the latter peak was found to correspond to poly(propylene oxide) having Mₙ of 1,100, and M_{w} of 1,800 (therefore, its M_{w}/Mₙ=1,800/1,100=1.6). Results are shown in Table 1.

### Example 3

Example 1 was repeated except that water was changed to 2.0 mmol of pentafluorobenzoic acid, thereby obtaining 0.55 g of poly(propylene oxide).

A GPC (gel permeation chromatography) measurement of the above-obtained poly(propylene oxide) indicated two peaks in a peak strength ratio of 36.5:63.5. The former peak was found to correspond to poly(propylene oxide) having Mₙ of 10,600,000, and M_{w}, of 21,200,000 (therefore, its M_{w}/Mₙ=21,200,000/10,600,000=2.0), and the latter peak was found to correspond to poly(propylene oxide) having Mₙ of 1,300, and M_{w} of 1,800 (therefore, its M_{w}/Mₙ=1,800/1,300=1.4). Results are shown in Table 1.

### Example 4

Example 1 was repeated except that the addition of 2.0 mmol of water was changed to addition of 2.0 mmol of water, then stirred for one hour, and then addition of 2.0 mmol of pentafluorophenol, thereby obtaining 0.48 g of poly(propylene oxide).

A GPC (gel permeation chromatography) measurement of the above-obtained poly(propylene oxide) indicated two peaks in a peak strength ratio of 41.4:58.6. The former peak was found to correspond to poly(propylene oxide) having Mₙ of 12,500,000, and M_{w} of 161,000,000 (therefore, its M_{w}/Mₙ=161,000,000/12,500,000=12.9), and the latter peak was found to correspond to poly(propylene oxide) having Mₙ of 1,200, and M_{w} of 1,700 (therefore, its M_{w}/Mₙ=1,700/1,200=1.4). Results are shown in Table 1.

### Example 5

Example 1 was repeated except that PMAO-S was changed to 10.0 mmol-Al of MAO-3A manufactured by TOSOH FINECHEM CORPORATION, thereby obtaining 0.93 g of poly(propylene oxide).

A GPC (gel permeation chromatography) measurement of the above-obtained poly(propylene oxide) indicated two peaks in a peak strength ratio of 61.1:38.9. The former peak was found to correspond to poly(propylene oxide) having Mₙ of 7,990,000, and M_{w} of 17,600,000 (therefore, its M_{w}/Mₙ=17,600,000/7,990,000=2.2), and the latter peak was found to correspond to poly(propylene oxide) having Mₙ of 1,300, and M_{w} of 1,800 (therefore, its M_{w}/Mₙ=1,800/1,300=1.4). Results are shown in Table 1.

### Example 6

Example 1 was repeated except that (i) PMAO-S was changed to 10.0 mmol-Al of MAO-3A manufactured by TOSOH FINECHEM CORPORATION, and (ii) 2.0 mmol of water was changed to 4.0 mmol of water, thereby obtaining 0.62 g of poly(propylene oxide).

A GPC (gel permeation chromatography) measurement of the above-obtained poly(propylene oxide) indicated two peaks in a peak strength ratio of 69.7:30.3. The former peak was found to correspond to poly(propylene oxide) having Mₙ, of 10,000,000, and M_{w} of 24,100,000 (therefore, its M_{w}/Mₙ=24,100,000/10,000,000=2.4), and the latter peak was found to correspond to poly(propylene oxide) having Mₙ of 1,300, and M_{w} of 1,800 (therefore, its M_{w}/Mₙ=1,800/1,300=1.4). Results are shown in Table 1.

### Example 7

Example 1 was repeated except that (i) PMAO-S was changed to 10.0 mmol-Al of MAO-3A manufactured by TOSOH FINECHEM CORPORATION, and (ii) 2.0 mmol of water was changed to 5.0 mmol of water, thereby obtaining 0.45 g of poly(propylene oxide).

A GPC (gel permeation chromatography) measurement of the above-obtained poly(propylene oxide) indicated two peaks in a peak strength ratio of 60.2:39.8. The former peak was found to correspond to poly(propylene oxide) having Mₙ of 7,310,000, and M_{w} of 18,300,000 (therefore, its M_{w}/Mₙ=18,300,000/7,310,000=2.5), and the latter peak was found to correspond to poly(propylene oxide) having Mₙ of 1,400, and M_{w} of 2,100 (therefore, its M_{w}/Mₙ=2,100/1,400=1.5). Results are shown in Table 1.

### Example 8

Example 1 was repeated except that (i) PMAO-S was changed to 10.0 mmol-Al of MMAO-3A manufactured by TOSOH FINECHEM CORPORATION, and (ii) 2.0 mmol of water was changed to 10.0 mmol of water, thereby obtaining 0.62 g of poly(propylene oxide).

A GPC (gel permeation chromatography) measurement of the above-obtained poly(propylene oxide) indicated two peaks in a peak strength ratio of 40.9:59.1. The former peak was found to correspond to poly(propylene oxide) having Mₙ of 19,700,000, and M_{w} of 39,400,000 (therefore, its M_{w}/Mₙ=39,400,000/19,700,000=2.0), and the latter peak was found to correspond to poly(propylene oxide) having Mₙ of 1,500, and M_{w} of 2,300 (therefore, its M_{w}/Mₙ=2,300/1,500=1.5). Results are shown in Table 1.

### Example 9

A toluene solution of PMAO-S (alumoxane compound) was weighed out in an amount corresponding to 10.0 mmol-Al of PMAO-S, by use of a 50 mL flask purged with nitrogen gas, the toluene solution of PMAO-S being manufactured by TOSOH FINECHEM CORPORATION. The toluene solution in the flask was diluted with 20 mL of dehydrated toluene. A 36 mg (2.0 mmol) of water (hydroxyl group-having compound), which had been degassed previously at room temperature, was added to the PMAO-S solution under stirring, and then the mixture was stirred for one hour. The resultant mixture was cooled down to −70° C., and 1.4 mL (20.0 mmol) of propylene oxide was added thereto. The mixture was stirred for 4 hours at room temperature, and then volatile components in the flask were removed under reduced pressure. The resultant material was washed two times with each 20 mL of dehydrated hexane, and was dried in vacuum for one hour, thereby yielding a white powder (pre-polymerized polymerization catalyst of an alkylene oxide).

To a 100 mL flask purged with nitrogen gas was charged 177 mg of the above-obtained white powder, and then 51.2 mL of dehydrated toluene was added thereto, thereby dissolving the white powder in toluene. A 6.0 mL of propylene oxide (alkylene oxide) was added to this toluene solution. The reaction mixture was stirred at 35° C. for 72 hours. The polymerization reaction was quenched by adding 3.0 mL of concentrated sulfuric acid. The mixture was neutralized with aqueous sodium hydroxide, and was separated into an oil layer and an aqueous layer. Volatile components in the oil layer were removed with a rotary evaporator, thereby obtaining 0.59 g of poly(propylene oxide).

A GPC (gel permeation chromatography) measurement of the above-obtained poly(propylene oxide) indicated two peaks in a peak strength ratio of 67.3:32.7. The former peak was found to correspond to poly(propylene oxide) having Mₙ of 9,570,000, and M_{w} of 23,000,000 (therefore, its M_{w}/Mₙ=23,000,000/9,570,000=2.4), and the latter peak was found to correspond to poly(propylene oxide) having Mₙ of 1,300, and M_{w} of 1,800 (therefore, its M_{w}/Mₙ=1,800/1,300=1.4). Results are shown in Table 2.

### Example 10

Example 9 was repeated except that PMAO-S was changed to 10.0 mmol of MMAO-3A, thereby obtaining 0.99 g of poly(propylene oxide).

A GPC (gel permeation chromatography) measurement of the above-obtained poly(propylene oxide) indicated two peaks in a peak strength ratio of 74.2:25.8. The former peak was found to correspond to poly(propylene oxide) having Mₙ of 5,480,000, and M_{w} of 12,100,000 (therefore, its M_{w}/Mₙ=12,100,000/5,480,000=2.2), and the latter peak was found to correspond to poly(propylene oxide) having Mₙ of 1,600, and M_{w} of 2,100 (therefore, its M_{w}/Mₙ=2,100/1,200=1.3). Results are shown in Table 2.

TABLE 1

| | Example | | | | | | | |
|---|---|---|---|---|---|---|---|---|
| | 1 | 2 | 3 | 4 | 5 | 6 | 7 | 8 |
| Alumoxane compound | PMAO-S | | | | MMAO-3A | | | |
| (10.0 mmol-Al used) | | | | | | | | |
| Hydroxyl group-having | | | | | | | | |
| compound (mmol used) | | | | | | | | |
| H₂O | 2.0 | | | 2.0 | 2.0 | 4.0 | 5.0 | 10.0 |
| C₆F₅OH | | 2.0 | | 2.0 | | | | |
| C₆F₅COOH | | | 2.0 | | | | | |
| Molar ratio of OH/A1 | 0.20 | 0.20 | 0.20 | 0.40 | 0.20 | 0.40 | 0.50 | 1.00 |
| poly (propylene oxide) | | | | | | | | |
| Yield (g) | 0.45 | 0.43 | 0.55 | 0.48 | 0.93 | 0.62 | 0.45 | 0.62 |
| Peak strength ratio | 40.5:59.5 | 43.1:56.9 | 36.5:63.5 | 41.4:58.6 | 61.1:38.9 | 69.7:30.3 | 60.2:39.8 | 40.9:59.1 |
| Former peak polymer | | | | | | | | |
| M_{w} | 29100000 | 50100000 | 21200000 | 161000000 | 17600000 | 24100000 | 18300000 | 39400000 |
| M_{w}/Mₙ | 1.9 | 8.5 | 2.0 | 12.9 | 2.2 | 2.4 | 2.5 | 2.0 |
| Latter peak polymer | | | | | | | | |
| M_{w} | 2300 | 1800 | 1800 | 1700 | 1800 | 1800 | 2100 | 2300 |
| M_{w}/Mₙ | 1.9 | 1.6 | 1.4 | 1.4 | 1.4 | 1.4 | 1.5 | 1.5 |

TABLE 2

Example

| | 9 | 10 |
|---|---|---|
| Alumoxane compound | PMAO-S | MMAO-3A |
| (10.0 mmol-Al used) | | |
| Hydroxyl group-having | | |
| compound (mmol used) | | |
| H₂O | 2.0 | 2.0 |
| Molar ratio of OH/Al | 0.2 | 0.2 |
| poly (propylene oxide) | | |
| Yield (g) | 0.59 | 0.99 |
| Peak strength ratio | 67.3:32.7 | 74.2:25.8 |
| Former peak polymer | | |
| M_{w} | 23000000 | 12100000 |
| M_{w}/Mₙ | 2.4 | 2.2 |
| Latter peak polymer | | |
| M_{w} | 1800 | 2100 |
| M_{w}/Mₙ | 1.4 | 1.3 |

1. A process for producing a polymerization catalyst of an alkylene oxide, comprising a step of contacting an alumoxane compound with a compound having a hydroxyl group.

2. The process according to claim 1, wherein the compound having a hydroxyl group is water, pentafluorophenol or pentafluorobenzoic acid.

3. A process for producing a poly(alkylene oxide), comprising a step of polymerizing an alkylene oxide in the presence of a polymerization catalyst of an alkylene oxide produced by the process of claim 1.

4. The process according to claim 3, wherein the compound having a hydroxyl group is water, pentafluorophenol or pentafluorobenzoic acid.

5. The process according to claim 3, wherein the alkylene oxide is propylene oxide.

6. A process for producing a pre-polymerized polymerization catalyst of an alkylene oxide, comprising steps of:
(1) contacting an alumoxane compound with a compound having a hydroxyl group, thereby forming a polymerization catalyst of an alkylene oxide; and
(2) pre-polymerizing an alkylene oxide in the presence of the polymerization catalyst of an alkylene oxide, an amount of the alkylene oxide pre-polymerized being 0.1 to 10 moles per one mole of an aluminum atom contained in the polymerization catalyst of an alkylene oxide.

7. The process according to claim 6, wherein the compound having a hydroxyl group is water, pentafluorophenol or pentafluorobenzoic acid.

8. A process for producing a poly(alkylene oxide), comprising a step of polymerizing an alkylene oxide in the presence of a pre-polymerized polymerization catalyst of an alkylene oxide produced by the process of claim 6.

9. The process according to claim 8, wherein the compound having a hydroxyl group is water, pentafluorophenol or pentafluorobenzoic acid.

10. The process according to claim 8, wherein the alkylene oxide is propylene oxide.
